(19) United States
(12) Patent Application Publication
(10) Pub. No.: US 2013/0279803 A1
(43) Pub. Date: Oct. 24, 2013

(54) METHOD AND SYSTEM FOR SMOKE DETECTION USING NONLINEAR ANALYSIS OF VIDEO

(71) Applicant: Ahmet Enis Cetin, Ankara (TR)

(72) Inventor: Ahmet Enis Cetin, Ankara (TR)

(21) Appl. No.: 13/825,006

(22) PCT Filed: Jan. 17, 2011
(86) PCT No.: PCT/US11/21486

§ 371 Date: Jul. 15, 2013

Related U.S. Application Data
(60) Provisional application No. 61/295,686, filed on Jan. 15, 2010.

(51) Int. Cl. G06K 9/00

(52) U.S. Cl. CPC G06K 9/00771
USPC 382/165

(57) ABSTRACT

The present invention describes a method and a system for detection of fire and smoke using image and video analysis techniques to detect the presence of indicators of fire and smoke. The method and the system detects smoke by transforming plurality of images forming the video captured by a camera into Nonlinear Median filter Transform (NMT) domain, implementing an “L1”-norm based energy measure indicating the existence of smoke from the MMT domain data, detecting slowly decaying NMT coefficients, performing color analysis in low-resolution NMT sub-images, using a Markov model based decision engine to model the turbulent behavior of smoke, and fusing the above information to reach a final decision about the existence of smoke within the viewing range of camera.

### BACKGROUND OF THE INVENTION

1. Field of the Invention

The present invention generally relates to the detection of fire and smoke, and in particular to use of image and video analysis techniques to detect the presence of indicators of fire and smoke.

2. Background Description

Conventional point smoke and fire detectors typically detect the presence of certain particles generated by smoke and fire by ionization or photometry. Point detectors cannot be operated in open spaces and it may take a long time for smoke particles to reach a detector in large rooms, atriums, etc. This, in turn, slows the response time of the point detectors which is very critical especially at the early stages of fire. The strength of using video in fire detection is the ability to serve large and open spaces. Current fire detection algorithms and methods are based on the use of color in video to detect the flames, as described, for example, in the article “Flame recognition in video” by W. Phillips III, M. Shah, and N. V. Lobo in Pattern Recognition Letters, c. 23 (1-3), s. 319-327, Ocak 2002; the article “A system for real-time fire detection” by G. Healey, D. Slater, T. Lin, B. Drda, and A, D. Goedeke in IEEE Computer Vision and Pattern Recognition Conference (CVPR) Proceedings '93, s. 605-606, 15-17 Haziran 1993; U.S. Pat. No. 6,844,818 to Grech-Cini et al (“Grech-Cini”).

U.S. Pat. No. 6,011,464 to Thuillard (“Thuillard”) describes a wavelet transform based method analyzing one dimensional (1-D) signals coming from a sensor belonging to a hazard detector system. The original sensor output signal is fed to multi-stage cascaded pairs of high-pass/low-pass filters. Association functions are assigned for high-pass filter outputs which are then analyzed using a set of fuzzy logic rules. An alarm is issued according to fuzzy logic rules. Thuillard fails to extend his method to two-dimensional (2-D) image sequences forming the video.

Japanese patent JP11144167 to Takatoshi et al

(“Takatoshi”) describes a fire detecting device based on flame detection only with the aim of eliminating false alarms due to artificial light sources, “especially rotating lamps”. Takatoshi fails to take advantage of smoke detection to eliminate false alarms.

An attempt has been made to use flicker on the flame boundaries and within flame regions as an indicator for the existence of flames within the viewing range of the visible or IR spectrum camera. PCT publication number WO02/069292 describes use of Fast Fourier Transforms (FFT) to compute temporal object boundary pixels to detect peaks especially around 10 Hz in Fourier domain. An important weakness of this method is that flame flicker is not purely sinusoidal but random. This makes it hard to detect peaks in FFT plots because they may not have a clear peak at 10 Hz due to the random nature of flames.

### SUMMARY OF THE INVENTION

It is therefore an object of the present invention to provide a technique that improves on the prior art by using smoke detection to eliminate false alarms and to provide an early indication of fire.

Another object of the invention is to improve on the prior art by employing a technique that reduces the computational requirements of fire and smoke detection.

It is also an object of the invention to provide a robust alternative to Fast Fourier Transforms for detection of flame flicker.

The invention provides a novel method and a system to detect smoke, fire and/or flame by processing the data generated by a group of sensors including ordinary cameras monitoring a scene in visible and infra-red spectrum. Video generated by the cameras are processed by a two-dimensional (2-D) nonlinear filter based on median operation. Flame and smoke flicker behavior is detected using Hidden Markov Models employing the output of the 2-D nonlinear filter to reach a decision.

One aspect of the invention is a method, a system and a device for accurately determining the location and presence of smoke due to fire and flames using video data captured by a camera. The method and the system detects smoke by a) transforming plurality of images forming the video into Nonlinear Median filter Transform (NMT) domain, b) implementing an “LL” energy based energy measure indicating the existence of smoke from the NMT domain data, c) detecting slowly decaying NMT coefficients, d) performing color analysis in low-resolution NMT sub-images, e) using a Markov model based decision engine to model the turbulent behavior of smoke, and f) fusing the above information to reach a final decision.

In a further aspect, the system and method computes the Nonlinear Median (NM) filter transforms of video image frames without performing any multiplication operations. Another aspect of the invention provides for searching all sub-images of NM transformed video data for slowly disappearing high amplitude NMT coefficients compared to the reference background NMT image, thereby indicating smoke activity.

It is also an aspect of the invention to provide a method and system that searches all NMT sub-images of transformed video data for newly appeared regions having energy less than the reference background NMT sub-images, thereby indicating existence of smoke. In a further aspect, the method and system of the invention calculates “L1”-norm based NMT energy function which does not require any multiplication operations. Another aspect of the invention carries out color content analysis on the low resolution sub-images of the NMT transformed video data to detect gray colored regions. In yet a further aspect, the invention is implemented by carrying out flicker and turbulent behavior analysis of smoke regions in video by using Markov models trained with NMT coefficients.

The method and system of the invention additionally g) performs an adaptive decision fusion mechanism based on the LMS (Least Mean Square) algorithm, h) creates a weighted mechanism for processed data fusion, i) combines processed data from a variety of camera outputs, and j) has memory and is able to recall on previously recorded decisions.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a schematic showing the basic building block of Nonlinear Median filter Transform (KMT).

FIG. 2 is a representation of a one-level nonlinear structure used in filtering a two-dimensional image and image frames of a video signal.

FIGS. 3A, 3B and 3C, respectively, are representations of two-level discrete-time nonlinear median transform decompositions for each color component (Y, U, and V, respectively) of a video frame.

FIG. 4 is a modification of a two-level discrete-time nonlinear median (NM) transform (as shown in FIGS. 3A, 3B and 3C) to show checking of a MM transformed sub-band image by dividing the sub-band image H1 into smaller pieces.

FIGS. 5A and 5B are schematic representations of three-state Markov models, for regions with fire/smoke (FIG. 5A) and regions without fire/smoke (FIG. 5B). The Markov model in FIG. 5A (with the “a” subscripts) models the behavior of smoke and the Markov model in FIG. 5B (with the “b” subscripts) models the motion of ordinary objects.

### DETAILED DESCRIPTION OF A PREFERRED EMBODIMENT OF THE INVENTION

The method of the invention constructs a 2-D nonlinearly filtered background image from a plurality of image frames and monitors the changes in some parts of the image by comparing the current nonlinearly filtered image to the constructed background image. This 2-D image and image frame analysis method of subband energy definition is distinct from the approach taken by Thuillard. Thuillard uses a Euclidean norm requiring squared sums, and cannot locate the exact location of the fire because his method makes use of a 1-D sensor output signal. The present invention does not use any multiplications. It uses median filtering and l1-norm requiring only absolute values, which is computationally much faster than Euclidean norm based energy calculations. Furthermore the approach of the present invention uses hidden Markov model (HMM) technology as the decision engine to detect fire within the viewing range of the camera. Also, the 2-D nonlinear image analysis of image frames makes it possible to estimate the location of smoke regions within image sequences.

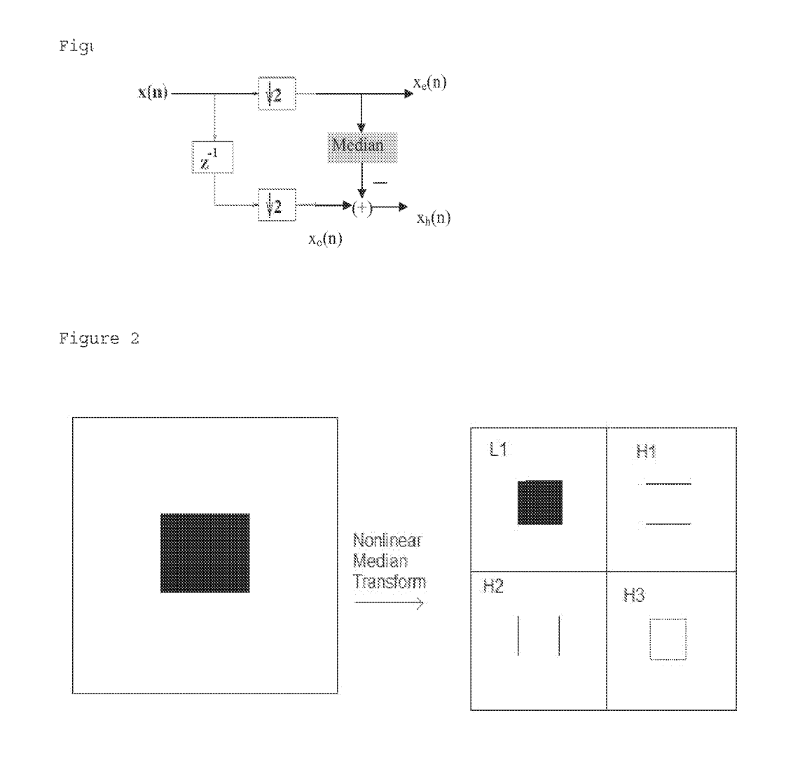

As indicated above, Takatoshi fails to take advantage of smoke detection to eliminate false alarms. However, in many fires, smoke rises into the view of sensors well before flames become visible. Takatoshi uses 2-D Continuous Wavelet Transform (CWT) for image analysis. By contrast, the present invention uses a discrete-time nonlinear filtering structure (FIG. 2), which is computationally more efficient than CWT because it does not require any multiplications. The present invention uses nonlinear median filters to obtain a plurality of sub-images for a given image. Furthermore, the present invention uses absolute values for change detection. This approach does not require any multiplications, either. However, Takatoshi uses a 2-D autocorrelation function requiring multiplications in a double-sum. This is computationally much more expensive than l1-norm based calculations.

As indicated above, the prior art uses FFT to detect flicker on the flame boundaries and within flame regions, but it is difficult to use FFT as an indicator for the existence of flames within the viewing range of the visible or IR spectrum camera because flicker is random rather than sinusoidal. The improvement of the present invention models flame flicker processes with Markov models. Also, the prior art Grech-Cini reference describes how edges are determined using the image space domain Sobel edge filter, which requires 8 multiplications to produce an output sample. The improvement provided by the present invention is the use of a nonlinear filter that does not use multiplication, which is computationaly faster than linear Sobel edge-detection filter. Furthermore sub-images used in the analysis are smaller in size than the output of the Sobel filter. The present invention does not require any multiplications, which leads to a low-cost field-programmable gate array (FPGA) implementation, although the invention may be implemented in other physical configurations. Another improvement of the present invention over the wavelet and Sobel operator based methods is that these other methods detect only edges of an image. On the other hand, the median filter does not smooth out the textured parts of an image, as is well-known by those skilled in the art. This is an advantage over the prior art because it can be used as an important clue for smoke detection. Blurred textured regions in the video may be due to smoke.

The invention not only detects smoke colored moving regions in video but also analyzes the motion of such regions for flicker estimation. Proposed method for smoke detection is based on comparing the nonlinearly filtered current image with an nonlinearly estimated background image. Smoke gradually smoothens sharp transitions in an image when it is not that thick to cover the scene. This feature of smoke is a good indicator of its presence in the field of view of the camera. Sharp transition and textured regions in an image frame produces high amplitude regions in a nonlinearly filtered image. Here is an overview of the nonlinear image analysis method.

The nonlinear filtering of a signal or an image or a video frame consists of processing discrete coefficients (pixels). In discrete nonlinear filtering structure shown in FIG. 1 we first process the image or a video frame horizontally. Each row of the image is filtered independently. Let x(n) represent a row of a given image I(n,m) or an image frame of the video. Let xₑ(n)=x(2n) and xₒ(n)=x(2n−1) represent the even and odd indexed samples of x(n), respectively. We define

xₕ(n) xₒ(n)−median[xₑ(n), xₑ(n−1),xₑ(n+1)] (1)

The median operation simply determines the middle value of xₑ(n), xₑ(n−1), xₑ(n+1) and does not require any multiplications. If the signal is smooth the median value will be close to xₒ(n) and xₕ(n) will be very close to zero. However, if there is a transition in the processed row of the image (e.g. xₑn) and xₑ(n+1) are significantly different from xₑ(n−1)) then the median value will be either xₑ(n) or xₑ(n+1) and xₕ(n) will be significantly different from zero. Therefore a high valued xₕ(n) indicates that there is a change in the value of the original signal x around the index 2n. In Eq. 1 the median filter is implemented using three samples but it can be implemented using four or more samples as well.

The output of the nonlinear filtering structure shown in FIG. 1 are xₑ(n) and xₕ(n), whose size is a half of the size of the original row x(n). Therefore, the structure shown in FIG. 1 produces two half sized images by processing each row of the original image. Let us call these images as Iₑ(n,m) and Iₕ(n,m). After this step two half-sized images are processed vertically column by column using the structure shown in FIG. 1. As a result four quarter size sub-images are obtained. We call this operation single-scale Nonlinear Median Transform (NMT) of the image.

FIG. 2 illustrates the nonlinear median transform of a luminance frame I of the video after a single-scale decomposition. This operation can be successively applied to decompose the original image into smaller size sub-images. After each stage of nonlinear filtering, four quarter size down-sampled sub-images are obtained. We call the first sub-image Low-1 (L1) sub-image. This image is simply the horizontally and vertically down sampled version of the original image I, i.e., L1(n,m)=I(2n,2m). The second sub-image is (H1) sub-image which is obtained after column-wise nonlinear processing of Iₑ(n,m). The third H2 and fourth H3 sub-images are obtained from Iₕ(n,m) by column-wise nonlinear filtering using the structure shown in FIG. 1. The difference sub-images H1, H2, and H3 contain transition value information of the original image I because of the subtraction operation in Equation 1. The sub-image L1₁ can be further decomposed into smaller size sub-images in a similar manner. The level of transform is denoted by a number following the two-letter code. For example, L1₁; H1₁, H2₁; H3₁ refer to the first scale of the nonlinear median transform. L1₂, H1₂, H2₂, H3₂ denote one-eighth size sub-images obtained from the L1₁ sub-image after the second stage nonlinear median transform.

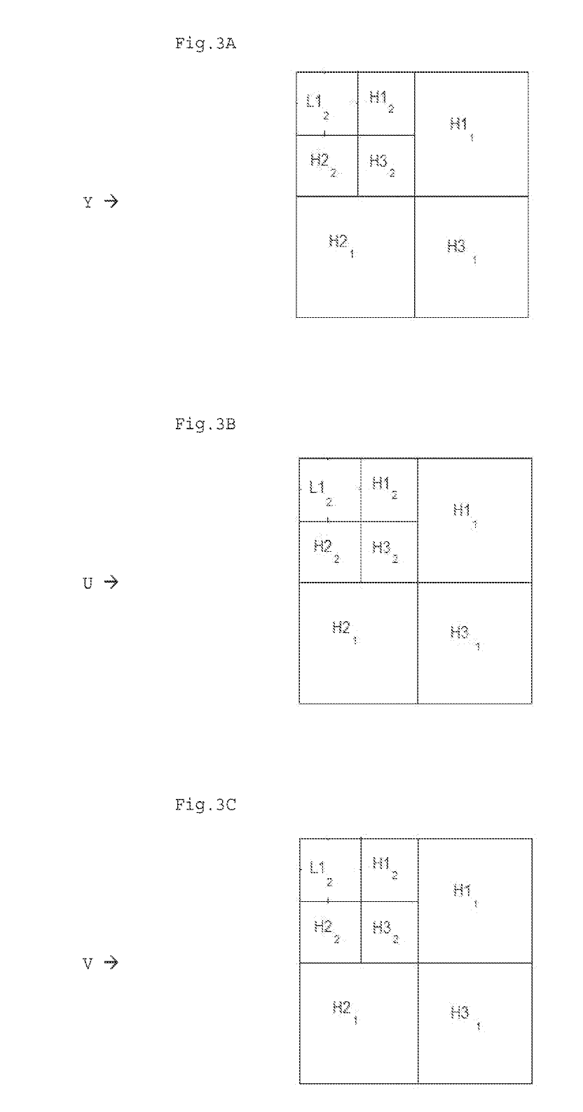

FIG. 3 illustrates further transforms that have been performed on the L1₁ sub-image. The second transform performed on the L1₁ quarter sized sub-image produces four second scale quarters within the L1₁ sub-image which are similar to the first level quarter-size images, where the second level sub-images are labelled as L1₂, H1₂, L2₂, and H3₂. A third transform performed on the L1₂ sub-image produces four third level sub-images (not shown) labelled as L1₃, H1₃, H2₃, and H3₃. A three-level median transform representation of a given image I consist of L1₁, H1₁, H2₁, H3₁, L1₂, H1₂; H2₂, H3₂, L1₃, H1₃, H2₃, and H3₃. As mentioned earlier, all of the above sub-images are obtained without performing any multiplications.

In this invention it is assumed that each image of the video is represented in median filter domain as described above. Other video formats have to be converted to raw data format first, and then converted to the nonlinear median transform representation.

Each image of a color video consists of three matrices corresponding to three color components: red, green, and blue, or widely used luminance (Y) and two color difference or chrominance (U and V fields) components. The method and the system can handle other color representation formats as well. A nonlinear median transform (NMT) can be computed separately for each color component, as shown in FIG. 3 by the respective matrices for “Y”, “U”, and “V”.

NMT coefficients contain spatial information about the original image. For example, the (n,m)-th coefficient of the sub-image H1₁ (or other sub-images H2₁, H3₁, L1₁) of the current image I is related with a two pixel by two pixel region in the original image pixel I(k,l), k=2n,2n−1, l=2m,2m−l because of the sub-sampling operation during the nonlinear median transform computation. In general, a change in the p-th level transform coefficient corresponds to a 2p by 2p region in the original image frame. If there is a significantly large value in the (n,m)-th coefficient of the HL₁ (LH₁) sub-image then this means that there is a significant vertical (horizontal) change around the (k,l)-th pixel of the original image. In other words, this means that there is an object boundary going through the (k,m)-th pixel of the original image or there is a textured object around the (k,m)-th pixel of the image.

In the present invention, a median filter based method known in the art is lased for background image estimation (see e.g. the public domain document: I. Haritaoglu, D. Harwood, L. S. Davis, “W4S: Real-time surveillance of people and their activities,” IEEE Trans. Pattern Anal. Mach. Intell., 2000). Other background estimation methods described in “Algorithms for cooperative multisensor surveillance” by R T Collins, A J Lipton, H Fujiyoshi, T Kanade, published in Proceedings of the IEEE, 2001 can also be used to estimate a background image.

The main assumption of the above methods is that the camera capturing the image frames should be stationary. Once moving regions are estimated by this known method, a nonlinear median transform based image analysis method is implemented to discriminate between smoke and other regular moving regions. When there is smoke in some parts of the image then the smoke obstructs the texture and edges in the background. Since the edges and texture contribute to high amplitude values in H1₁, H2₁ and H3₃ sub-images, energies of these sub-images drop due to smoke in an image sequence. It is also possible to determine the location of smoke using the sub-images, because they also contain spatial information as described above. In the Grech-Cini reference, edges are determined using the image space domain Sobel edge filter. The NMT domain analysis of the present invention is computationaly faster than Grech-Cini's image space domain because nonlinear median transformed images are smaller in size than the actual image and they can be computed without performing any multiplications.

Let

wₙ(x,y)=|Hₙ(x,y)|+|H2ₙ(x,y)|+|H3ₙ(x,y) (2)

represent a composite image containing median difference sub-images corresponding to n-th level nonlinear median transform. In Eq. 1 we construct an “l1-norm” based energy function which also does not require any multiplications. This image is divided into small blocks of size (K₁, K₂) and the energy of each block e(I₁,I2) is computed as follows

e(l₁,l₂)=Σ_{(x,y)}wₙ(x+l₁K₁,y+l₂K₂) (3)

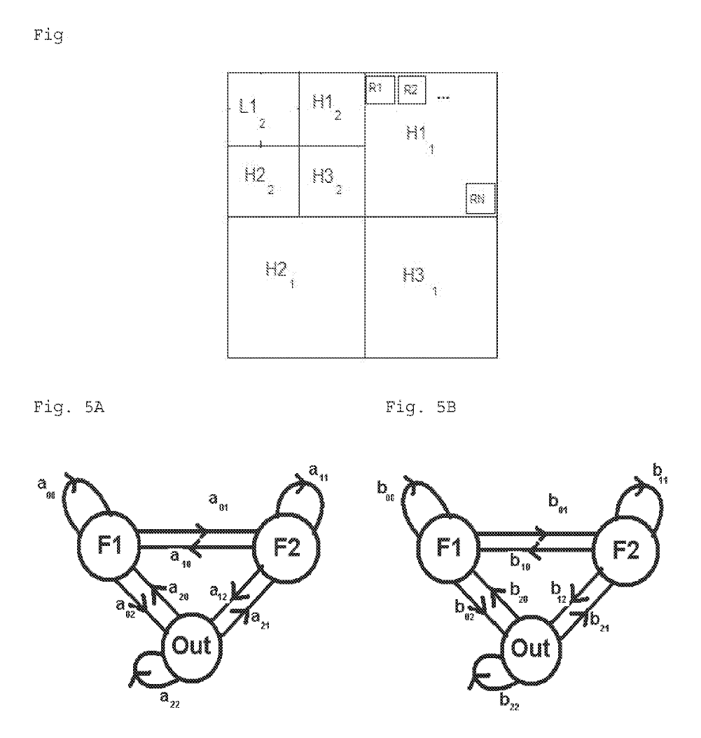

This is shown in FIG. 4. The small regions marked as R₁, R₂, . . . , R_{N} represent blocks of size (K₁, K₂) in the H1 wavelet image. If the NMT sub-images H1ₙ, H2ₙ, H3ₙ are computed from the luminance (Y) image then there is no need to include the chrominance U and V color components because most of the image amplitude information is available in the Y component. If the NMT transform of R, G, and B colour images are computed then the energy e(l₁, l₂) is computed using all of the NMT sub-images of the R, G, and B color images.

The above local energy values computed for the NMT of the current image are compared to the corresponding NMT of the background image which contains information about the past state of the scene under observation. If there is a decrease in value of a certain e(l₁, l₂) then this means that the texture or edges of the scene monitored by the camera no longer appear as sharp as they used to be in the current image of the video. Therefore, there may be smoke in the image region corresponding to the (l₁, l₂)-th block.

One can set up thresholds for comparison. If a certain e(l₁, l₂) value drops below the pre-set threshold this may be an indicator of existence of smoke in the region. Let D₁ be a decision variable which becomes 1 when the e(l₁, l₂) value drops below the pre-set threshold in some part of the image frame of the video. Otherwise D₁ is zero. One can also define different sensitivity levels to different parts of the image by defining different threshold values for different (l₁, l₂) indices.

Edges in the current image frame of the video produce high amplitude values in NMT difference sub-images because of the subtraction operation in Eq. 1. If smoke covers one of the edges of the current image then the edge initially becomes less visible and after some time it may disappear from the scene as the smoke gets thick.

Let the NMT coefficient H1ₙ(x,y) be one of the transform coefficients corresponding to the edge covered by the smoke. Initially, its value decreases due to reduced visibility, and in subsequent image frames it becomes either zero or close to zero whenever there is very little visibility due to thick smoke. Therefore locations of the edges of the original image are determined from the high amplitude coefficients of the NM transform of the background image in the system of the invention. Slow fading of a NMT coefficient is an important clue for smoke detection. If the values of a group of NMT coefficients along a curve corresponding to an edge decrease in value in consecutive frames then this means that there is less visibility in the scene. In turn, this may be due to the existence of smoke.

An instantaneous disappearance of a high valued NMT coefficient in the current frame cannot be due to smoke. Such a change corresponds to a moving object and such changes are ignored. One can set up thresholds for comparison. If the value of a high-valued KMT coefficient drops below a preset threshold or drops a pre-determined percentage of its original value this is an indicator of the smoke. Let D₂ be a decision variable which becomes 1 when the value of a certain NMT coefficient drops below the preset threshold in some part of the image frame of the video. Otherwise D₂ is zero. We can assign fractional values to the decision variable according to the rate of decrease as well (e.g. a 10% decrease may make D₂=0.1, a 20% decrease may make D₂=0.2 etc). One can also define different sensitivity levels to different parts of the image by defining different threshold or percentage values for different image regions.

Smoke colored regions are detected in low resolution L1 sub-images. This is possible because the L1 family of sub-images contains essentially actual image pixel values. Although there are various types of fires, smoke does not have any color. Therefore, the color difference U and V components of a smoke pixel should be ideally equal to zero. Small threshold values can be put around U and V values to check if a moving region in video has no color. If U and V pixel values are close to zero this is also an indicator of the existence of smoke in the scene. If the color space of the video is Red (R), Green (G), Blue (B) it can be transformed into <Y,U,V> or <Y,Cb,Cr> color spaces (chrominance Cb and Cr values must be ideally equal to 128 for a colorless object).

NMT domain color analysis is computationaly faster than image space domain color analysis because the L1 family of sub-images is smaller in size than the actual image. If a moving region is gray colored then the decision variable D₃ may become 1. Otherwise D₃ will be equal to 0. Fractional values can be assigned to the decision variable D₃, too.

Flicker on the flame boundaries and within flame regions can be used as an indicator for the existence of flames and smoke within the viewing range of the camera. It is known in the art to compute Fast Fourier Transforms (FFT) of temporal object boundary-pixels to detect peaks especially around 10 Hz in Fourier domain (PCT publication number WO02/Q69292). An important weakness of Fourier domain methods is that flame flicker is not purely sinusoidal but random. Consequently, peaks cannot be detected with precision in FFT plots. In order to overcome this deficiency the present invention uses a different approach, which is to model the flame flicker process using Markov models. Smoke does not flicker as much as flames but it has a turbulent behavior related with flame flicker. Therefore, a Markov model based stochastic approach is ideal to represent the smoke motion in video.

In the prior art shapes of fire regions have been represented in Fourier domain. Fourier Transform does not carry any time (space) information. In order to make FFTs also carry time information, they have to be computed in windows of data. Hence, temporal window size is very important for detection. If the window size is too long, then one may not observe the incidence of peaks in the FFT data. If it is too short, then one may completely miss cycles and therefore no peaks can be observed in the Fourier domain.

A smoke behavior process is modeled with three state hidden Markov models as shown in FIG. 5. One of the Markov models, having “a” subscripts, corresponds to smoke boundary pixels. The Markov model with “b” subscripts models the motion of regular gray colored object pixels. Markov models are trained with the feature vector defined as follows: let Iₜ (k) be the intensity value of the k′th pixel at frame t and wₜ (k) be the composite NMT coefficient defined in Equation 2 corresponding to the pixel Iₜ (k). Slow variations in the original image lead to zero-valued NMT coefficients. Hence it is easier to set thresholds in the NMT domain to distinguish slow varying signals from rapidly changing pixels. Non-negative thresholds T₁<T₂ are introduced in the NMT domain to define the three states of the hidden Markov Models (MM) for smoke and other gray colored moving objects. The states of MMs are defined as follows: at time n, if |wₜ (k)|<T₁, the state is in F1; if T₁<|wₜ(n)|<T₂, the state is F2; else if |wₜ(n)|>T₂, the state “Out” is attained. In smoke boundary pixels, the transition probabilities aᵢⱼ should be high and close to each other due to the random nature of uncontrolled fire. On the other hand, transition probabilities should be small in ordinary moving objects, because there is no change or little change in pixel values. Hence the probability b₀₀ should be higher than any other bₓₓ value in the Markov model of nonflame or non-smoke moving pixels. This means that in ordinary moving objects the state F1 should be attained with a higher probability. The state F2 provides hysteresis and it prevents sudden transitions from F1 to “Out” or vice versa. Transition probabilities corresponding to smoke and non-smoke pixels are estimated off-line in the training phase of the smoke detection system.

In the system according to the invention, candidate smoke regions are detected by color (brightness) analysis in the L1 sub-band images captured by a visible range camera. Twenty-frames-long state sequences of each of the pixels in these candidate regions are determined by the Markov model analysis described above. The model yielding higher probability is determined as the result of the analysis for each of the candidate pixels. Probability of a Markov model can also be computed without performing any multiplication (see the book Fundamentals of Speech Recognition by L R Rabiner, B H Juang, 1993, Prentice-Hall). If probability of model A is higher than the probability of model B for a given pixel then the decision variable D₄ is set to 1. Otherwise the decision variable is D₄=0.

Decision Fusion

Decision variables, D₁, D₂, D₃ and D₄ obtained via the NMT based analysis of a video signal are fused to reach a final decision. Multi-sensor data fusion methods include decision fusion based on voting, Bayesian inference, and Dampster-Shafer methods. We can use these multi-sensor decision fusion methods to combine the decision results. In this section, we describe two methods, a voting based decision fusion strategy and an LMS (least mean square) based decision fusion strategy. However, other data fusion methods can be also used to combine the decision of individual sensors.

Voting schemes include unanimity voting, majority voting, m-out-of-n voting in which an output choice is accepted if at least m votes agree out of the decisions of n sensors. A variant of m-out-of-n voting is the so-called t-out-of-V voting in which the output is accepted if

H=ΣwᵢDᵢ>T (4)

where wᵢ's are the user-defined weights, Dᵢ's are the decisions of the sensors, and T is a user-defined threshold. Decision parameters of the sensors Dᵢ can take binary values, 0 and 1 corresponding to normal case and the existence of fire, respectively. Each Dᵢ can also take any real value between 0 and 1, if there is an associated model for the i-th decision variable.

With the use of binary decision variables it is possible to have a smoke detection scheme without requiring any multiplications because the NMT transform, the Markov model probability computation and the decision fusion step do not require any multiplications. This is an important advantage in FPGA implementation because multiplication units occupy a huge area in the FPGA preventing a low-cost solution.

In the LMS method, let the final decision is composed of N-many decision functions: D₁, . . . , D_{N} corresponding to different sensors. Upon receiving a sample input x, at time step n, each sensor yields a decision Dᵢ(x,n) which takes real values from the range [0,1]. As the value gets closer to 1, the decision is fire and as it gets closer to 0 it corresponds normal case. The type of sample input x may vary depending on the algorithm. In our case, each incoming image frame is considered as a sample input.

In the adaptive decision fusion scheme of the invention, weights are updated according to the LMS algorithm which is the most widely used adaptive filtering method. Another innovation that we introduced is that individual decision algorithms do not produce binary values 1 (correct) or 0 (false). They produce a real number between 1 and 0, i.e., Dᵢ(x,n) takes real values in the range [0,1].

Let D(x,n)=[D₁(x,n) . . . D_{N}(x,n)]^{T}, be the vector of decisions of the sensors for the input image frame x at time step n. The weight adaptation equation is as follows:

$$w ( n + 1 ) = w ( n ) + μ \frac{e ( x , n )}{{‖ D ( x , n ) ‖}^{2}} D ( x , n ) \qquad ( 5 )$$

where w (n) =[w₁(n) . . . w_{N}(n)], is the current weight vector. The adaptive algorithm converges, if Dᵢ(x,n) are wide-sense stationary random processes and when the update parameter μ lies between 0 and 2. The computational cost can be reduced by omitting the normalization norm ∥D(x,n)∥² and by selecting a μ close to zero.

The weights are unconditionally updated using LMS adaptation in Eq (5). The error e(x,n) is estimated as follows:

$$e ( x , n ) = y ( x , n ) - {\sum }_{i} {w}_{i} ( n ) {D}_{i} ( x , n ) \qquad ( 6 )$$

where y(x,n)ε{−1,1} is user's classification result.

The laser anticipate actively in the learning process by disclosing her/his classification result, y(x,n), on the input image frame x at time step n.

The decision fusion method as well as the other methods such as wavelet transform computation, wavelet domain energy calculations, hidden Markov model computations etc., described herein, are preferably implemented using program instructions (software, firmware, etc.) that can be executed by a computer system and are stored on a computer readable medium, such as memory, hard drive, optical disk. (CD-ROM, DVD-ROM, etc.), magnetic disk, etc.

Alternatively, these methods can be implemented in hardware (logic gates, Field Programmable Gate Arrays, etc.) or a combination of hardware and software.

While the invention has been described in terms of preferred embodiments, those skilled in the art will recognize that the invention can be practiced with modification within the spirit and scope of the appended claims.

Having thus described my invention, what I claim as new and desire to secure by Letters Patent is as follows:

1. A computer implemented method of determining the location and presence of smoke due to fire, the method comprising:
transforming a plurality of video images into Nonlinear Median filter Transform (NMT) domain, the video images having been captured by a camera;
implementing an “L1”-norm based energy measure indicating the existence of smoke from the NMT domain data;
detecting slowly decaying NMT coefficients;
performing color analysis in low-resolution NMT subimages;
using a Markov model based decision engine to model the turbulent behavior of smoke; and
fusing the above information to reach a final decision.

2. The method of claim 1, wherein the Nonlinear Median (NM) filter transforms of video image frames are computed without performing any multiplication operations.

3. The method of claim 1, wherein subimages of NM transformed video data are searched for high amplitude NMT coefficients that are slowly-disappearing compared to a reference background NMT image, said slowly disappearing NMT coefficients indicating smoke activity.

4. The method claim 1, wherein subimages of transformed video data are searched for newly appearing regions having energy less than a reference background NMT image, said newly appearing regions indicating existence of smoke.

5. The method of claim 1, wherein the “L1”-norm based NMT energy function computation does not require any multiplication operations.

6. The method of claim 1, wherein a color content analysis on low resolution subimages of the NMT transformed video data is carried out to detect gray colored regions.

7. The method of claim 1, further comprising carrying out flicker and turbulent behavior anal-ysis of smoke regions in video by using Markov models trained with NMT coefficients.

8. The method of claim 1, further comprising:
performing an adaptive decision fusion mechanism based on the LMS (Least Mean Square) algorithm;
creating a weighted mechanism for processed data fusion; and
combining processed data from a plurality of camera outputs.

9. A computer implemented system of determining the location and presence of smoke due to fire, comprising:
means for transforming a plurality of video images into Nonlinear Median filter Transform (NMT) domain, the video images having been captured by a camera;
means for implementing an “L1”-norm based energy measure indicating the existence of smoke from the NMT domain data;
means for detecting slowly decaying NMT coefficients;
means for performing color analysis in low-resolution NMT subimages;
means for using a Markov model based decision engine to model the turbulent behavior of smoke; and
means for fusing the above information to reach a final decision.

10. The system of claim 9, wherein the Nonlinear Median (NM) filter transforms of video image frames are computed without performing any multiplication operations.

11. The system of claim 9, wherein subimages of NM transformed video data are searched for high amplitude NMT coefficients that are slowly disappearing compared to a reference background NMT image, said slowly disappearing NMT coefficients indicating smoke activity.

12. The system of claim 9, wherein subimages of transformed video data are searched for newly appearing regions having energy less than a reference background NMT image, said newly appearing regions indicating existence of smoke.

13. The system of claim 9, wherein the “L1”-norm based NMT energy function computation does not require any multiplication operations.

14. The system of claim 9, wherein a color content analysis on low resolution subimages of the NMT transformed video data is carried out to detect gray colored regions.

15. The system of claim 9, further comprising means for carrying out flicker and turbulent behavior analysis of smoke regions in video by using Markov models trained with NMT coefficients.

16. The system of claim 9, further comprising:
means for performing an adaptive decision fusion mechanism based on the LMS (Least Mean Square) algorithm;
means for creating a weighted mechanism for processed data fusion; and
means for combining processed data from a plurality of camera outputs.
